(19) United States
(12) Patent Application Publication
(10) Pub. No.: US 2021/0107455 A1
(43) Pub. Date: Apr. 15, 2021

(54) Vehicle Motion State Estimation Apparatus, Vehicle Motion State Estimation System, Vehicle Motion Control Apparatus, and Vehicle Motion State Estimation Method

(71) Applicant: Hitachi Automotive Systems, Ltd., Hitachinaka-shi, Ibaraki (JP)

(72) Inventors: Daiki NAITO, Yokohama-shi, Kanagawa (JP); Satoshi KASHIWAMURA, Atsugi-shi, Kanagawa (JP)

(21) Appl. No.: 16/644,276

(22) PCT Filed: Aug. 30, 2018
(86) PCT No.: PCT/JP2018/032097

§ 371 Date: Mar. 4, 2020

(30) Foreign Application Priority Data
Sep. 12, 2017 (JP) 2017-174566

(51) Int. Cl. B60W 30/02; B60W 40/114; B60W 40/109; B60W 10/18; B60W 10/20

(52) U.S. Cl. CPC B60W 30/02; B60W 40/114; B60W 40/109; B60W 2520/06; B60W 10/20; B60W 2520/14; B60W 2520/10; B60W 10/18

(57) ABSTRACT

In the present invention, a controller includes: a first vehicle behavior signal input portion configured to input a first vehicle behavior signal obtained based on acquired position information on an own vehicle and a speed in a longitudinal direction of the own vehicle; a second vehicle behavior signal input portion configured to input a second vehicle behavior signal detected by a vehicle behavior detection portion; and a motion state estimation portion configured to estimate a first motion state of the own vehicle based on the first vehicle behavior signal and the second vehicle behavior signal.

### TECHNICAL FIELD

The present invention relates to a vehicle motion state estimation apparatus, a vehicle motion state estimation system, a vehicle motion control apparatus, and a vehicle motion state estimation method.

### BACKGROUND ART

In Patent Literature 1, there is disclosed a technology of estimating a vehicle motion state. Specifically, a lateral acceleration detection value, a longitudinal speed detection value, and a yaw rate detection value are input to an observer, which is based on a lateral-direction motion equation and a longitudinal-direction motion equation of a vehicle. Then, a vehicle body lateral slip angle is calculated from a lateral speed estimation value and a longitudinal speed estimation value, which are obtained from this input. In this case, each of the lateral acceleration detection value and the longitudinal acceleration detection value are corrected based on an error between the longitudinal speed detection value and the longitudinal speed estimation value, to thereby increase the accuracy of estimation in a non-linear area of a tire characteristic.

### CITATION LIST

### Patent Literature

PTL 1: JP 2014-108728 A

### SUMMARY OF INVENTION

### Technical Problem

In general, during bank travel, in which a lateral acceleration sensor is affected by the gravity, a lateral acceleration detection value decreases so that a separation occurs in a relationship between the yaw rate and the lateral acceleration, and a correction is thus made so as to cancel the influence of the gravity. However, the separation between the yaw rate and the lateral acceleration during the bank travel and a separation therebetween during a moderate spin (hereinafter referred to as “slow spin”) are very similar to each other, and it is thus difficult to determine whether the vehicle is traveling on a bank or presenting the slow spin. Therefore, there is a fear in that, even when the vehicle is actually spinning, this state may be determined as the bank travel so that the separation between the yaw rate and the lateral acceleration caused by the spin is corrected, resulting in a failure to accurately recognize the motion state of the vehicle. This is a problem similarly in a technology using the lateral acceleration sensor as described above.

Therefore, it is an object of the present invention to provide a vehicle motion state estimation apparatus, a vehicle motion state estimation system, a vehicle motion control apparatus, and a vehicle motion state estimation method, which are capable of increasing the accuracy of estimation of a motion state of a vehicle.

### Solution to Problem

In one embodiment of the present invention, a controller includes: a first vehicle behavior signal input portion configured to input a first vehicle behavior signal obtained based on acquired position information on an own vehicle and a speed in a longitudinal direction of the own vehicle; a second vehicle behavior signal input portion configured to input a second vehicle behavior signal detected by a vehicle behavior detection portion; and a motion state estimation portion configured to estimate a first motion state of the own vehicle based on the first vehicle behavior signal and the second vehicle behavior signal.

According to one embodiment of the present invention, the position information of the own vehicle is not influenced by the gravity, and the accuracy of estimation of the motion state of the vehicle can thus be increased.

### BRIEF DESCRIPTION OF DRAWINGS

FIG. 1 is a diagram for illustrating a control system for a vehicle in a first embodiment of the present invention.

FIG. 2 is a block diagram for illustrating a control configuration of a controller in the first embodiment.

FIG. 3 is a flowchart for illustrating motion state estimation processing in the first embodiment.

FIG. 4 is a control block diagram for illustrating a control configuration of a motion state estimation portion 12d in a second embodiment of the present invention.

FIG. 5 is a control block diagram for illustrating a control configuration of the motion state estimation portion 12d in a third embodiment of the present invention.

FIG. 6 is a control block diagram for illustrating spin determination processing in a fourth embodiment of the present invention.

### DESCRIPTION OF EMBODIMENTS

### First Embodiment

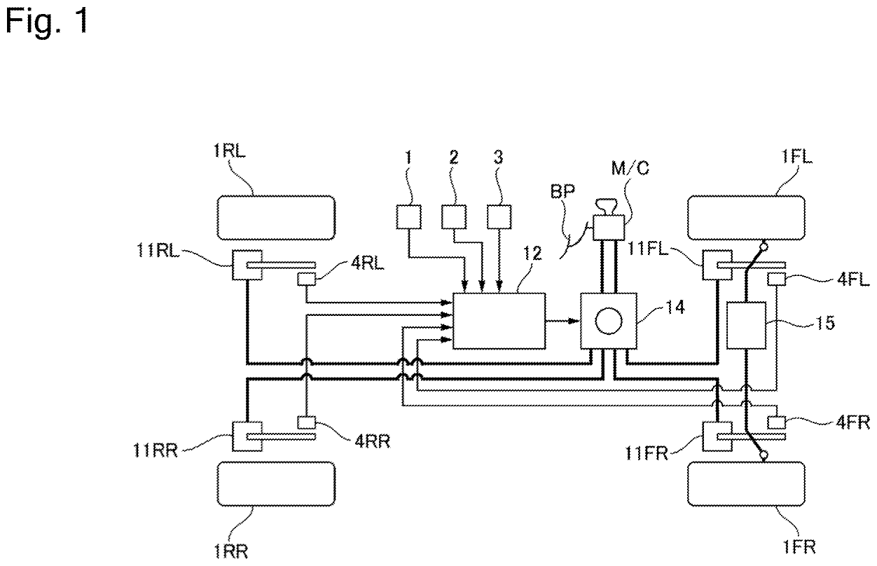

FIG. 1 is a diagram for illustrating a control system for a vehicle in a first embodiment of the present invention. The vehicle in the first embodiment includes front wheels FL and FR, and rear wheels RL and RR (hereinafter also simply referred to as “front wheels” and “rear wheels”, or “wheels”). Each of the wheels includes a brake unit 11FL, 11FR, 11RL, or 11RR (hereinafter, also simply referred to as “brake unit 11”) configured to generate a frictional braking force through a hydraulic pressure. A master cylinder M/C is configured to generate a master cylinder pressure in accordance with an operation on a brake pedal BP, to thereby supply the master cylinder pressure to a brake control apparatus 14. The brake control apparatus 14 is configured to supply, as a wheel cylinder pressure, the master cylinder pressure or a control brake pressure generated in accordance with a travel state to the brake units 11. Moreover, the brake control apparatus 14 uses ABS to execute processing so as to reduce, hold, or increase the wheel cylinder pressure, and uses VDC to execute processing so as to increase the wheel cylinder pressure. The brake unit 11 is configured to apply a braking torque to a corresponding wheel 1FL, 1FR, 1RL, or 1RR in accordance with the supplied brake hydraulic pressure. Each of the wheels includes a wheel speed sensor 4FL, 4FR, 4RL, or 4RR (hereinafter, also simply referred to as “wheel speed sensor 4”) configured to detect a wheel speed. A steering apparatus 15 is an actuator configured to steer the front wheels, and is configured to control an axial motion state of a rack bar.

The vehicle includes a GPS sensor 1, a yaw rate sensor 2, a lateral acceleration sensor 3, and a controller 12. The GPS sensor 1 is configured to acquire position information on the own vehicle. The yaw rate sensor 2 is configured to detect a yaw rate of the own vehicle. The lateral acceleration sensor 3 is configured to detect a lateral acceleration of the own vehicle. The controller 12 is configured to control the brake control apparatus 14. The controller 12 includes an input portion configured to input information from the various sensors 1, 2, 3, and 4. The controller 12 is configured to execute antilock brake control (hereinafter referred to as “ABS”) of monitoring a lockup tendency of each wheel, and avoiding lockup when the lockup tendency increases. The ABS is a widely-known technology of reducing the brake hydraulic pressure in the brake unit 11 presenting the lockup tendency, storing brake fluid in a reservoir included in the brake control apparatus 14, and then, driving a pump so as to circulate the brake fluid to the master cylinder M/C. Moreover, the controller 12 is configured to monitor a turning state of the vehicle, and, when an understeer tendency or an oversteer tendency increases, the controller 12 executes vehicle dynamics control (hereinafter referred to as “VDC”) of executing control toward a neutral steer. The VDC is a widely-known technology of driving the pump so as to supply the control brake pressure to the brake unit 11 for a target wheel so that a yaw moment toward the neutral steer is generated.

Moreover, in a normal case, the controller 12 functions as a power steering apparatus configured to calculate a steering assist torque in accordance with a steering torque of a driver, to thereby operate the steering apparatus 15. Moreover, during automatic driving, the controller 12 controls the steering apparatus 15 based on commands from other controllers, to thereby control steered wheel angles of the front wheels so as to cause the own vehicle to travel on a desired route. Moreover, when an emergency avoidance or assist for the steering operation is to be executed, the controller 12 corrects a steering assist torque of the steering apparatus 15, so as to control a motion state of the vehicle while reducing a steering load imposed on the driver.

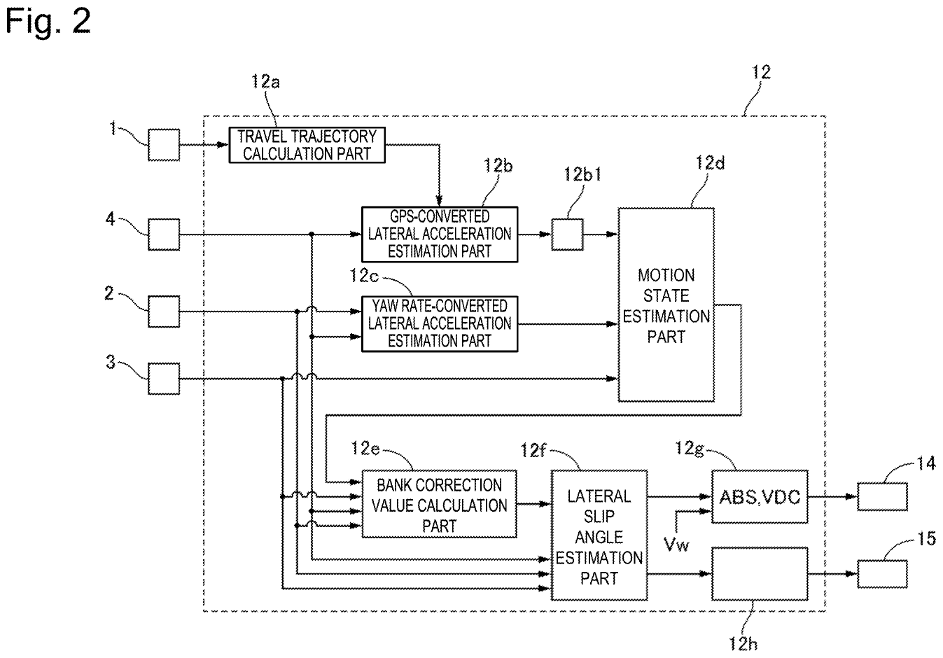

FIG. 2 is a block diagram for illustrating a control configuration of the controller in the first embodiment.

A travel trajectory calculation portion 12a is configured to calculate a travel trajectory of the vehicle based on the GPS sensor 1. The travel trajectory is calculated through use of the following method. First, the position of the own vehicle is acquired as freely-selected three points “a”, “b”, and “c” in a planar coordinate system.

a: (x1, y1), b: (x2, y2), c: (x3, y3). When the radius of a circle (radius of turning) passing those three points is represented by “r”, and the center of the circle is represented by (p, q), the following three equations are established based on a circle equation: (Expression 1) (x1−p)²+(y1−q)²=r², (Expression 2) (x2−p)²+(y2−q)²=r², and (Expression 3) (x3−p)²+(y3−q)²=r². Those three equations are solved as simultaneous equations, and the following (Expression 4) and (Expression 5) are obtained by rearrangement in terms of “p” and “q”: (Expression 4) p={(x1²−x2²+y1²−y2²)(y1−y3)−(x1²−x3²+y1²−y3²)(y1−y2)}/2{(x1−x2)(y1−y3)−(x1−x3)(y1−y2)}, and (Expression 5) q=(x1²−x3²+y1²−y3²−2(x1−x2)p)/(2(y1−y3)).

The radius “r” is calculated by assigning the center coordinate (p, q) of the circle obtained from (Expression 4) and (Expression 5) to (Expression 1). Moreover, through calculation of an outer product cp of a vector from the point “a” to the center of the circle and a vector from the point “a” to the point “c”, the following (Expression 6) is obtained: (Expression 6) cp=(x3−x1)(q−y1)−(y3−y1)(p−x1) When cp>0, the vehicle is determined to be in a left turning state. When cp<0, the vehicle is determined to be in a right turning state.

A GPS-converted lateral acceleration estimation portion 12b is configured to calculate a GPS-converted lateral acceleration YG (GPS) given by the following equation, based on the radius of turning “r” calculated by the travel trajectory calculation portion 12a, and a vehicle speed V calculated from wheel speeds Vw detected by the wheel speed sensors 4: YG (GPS)=V²/r. A GPS-converted yaw rate YR (GPS) can be given by the following equation: YR(GPS)=V/r. A filter processing portion 12b1 applies filter processing to the GPS-converted lateral acceleration YG (GPS) so as to remove noise. This is because the GPS-converted lateral acceleration YG (GPS) contains a large amount of noise, and is thus difficult to be used directly.

A yaw rate-converted lateral acceleration estimation portion 12c is configured to calculate a yaw rate-converted lateral acceleration YG (YR) given by the following equation from a yaw rate sensor value YR detected by the yaw rate sensor 2 and the vehicle speed V: YG(YR)=YR×V.

A motion state estimation portion 12d is configured to estimate a motion state based on the GPS-converted lateral acceleration YG (GPS), the yaw rate-converted lateral acceleration YG (YR), and a lateral acceleration sensor value YG detected by the lateral acceleration sensor 3.

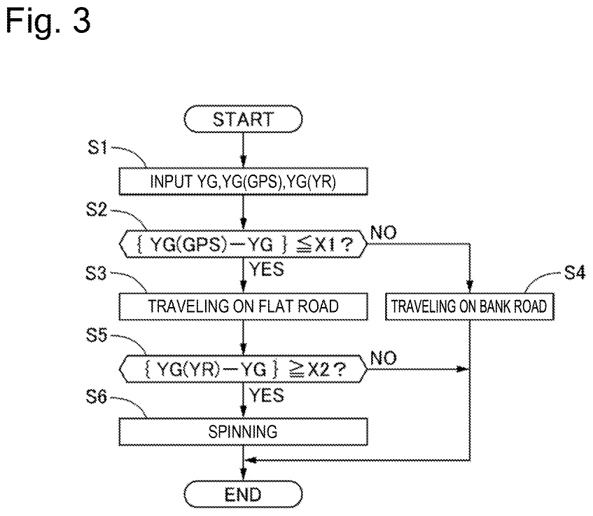

FIG. 3 is a flowchart for illustrating motion state estimation processing in the first embodiment.

In Step S1, the lateral acceleration sensor value YG, the GPS-converted lateral acceleration YG (GPS), and the yaw rate-converted lateral acceleration YG (YR) are input.

In Step S2, it is determined whether or not the absolute value of a deviation between the lateral acceleration sensor value YG and the GPS-converted lateral acceleration YG (GPS) is equal to or smaller than a predetermined value X1. When the absolute value is equal to or smaller than X1, the processing proceeds to Step S3, and determines that the vehicle is traveling on a flat road. When the absolute value is larger than X1, the processing proceeds to Step S4, and determines that the vehicle is traveling on a bank road. In this case, the predetermined value X1 is a value at which the lateral acceleration sensor value YG and the GPS-converted lateral acceleration YG (GPS) are separated from each other so that the vehicle can be determined to be traveling on a bank road. In other words, when the vehicle is traveling on a flat road, the values approximately match each other, but the lateral acceleration sensor value YG is reduced by influence of the gravity due to the influence of the bank road.

In Step S5, it is determined whether or not a deviation between the lateral acceleration sensor value YG and the yaw rate-converted lateral acceleration YG (YR) is equal to or larger than a predetermined value X2. When the deviation is equal to or larger than X2, the processing proceeds to Step S6, and determines that the vehicle is spinning. When the deviation is smaller than X2, the processing finishes this control flow. In this case, the predetermined value X2 is a value at which the lateral acceleration sensor value YG and the yaw rate-converted lateral acceleration YG (YR) are separated from each other so that a spin can be determined to be occurring. The lateral acceleration sensor value YG decreases during the bank travel, in which the lateral acceleration sensor is influenced by the gravity, and a separation occurs in the relationship between the yaw rate and the lateral acceleration. However, the separation during the bank travel and a separation between the yaw rate and the lateral acceleration during a slow spin are very similar to each other, and it is thus difficult to determine whether the vehicle is executing the bank travel or presenting the slow spin. Thus, in Step S2, a slow spin can accurately be detected by determining an occurrence of a spin based on the deviation between the lateral acceleration sensor value YG and the yaw rate-converted lateral acceleration YG (YR) after the determination that the vehicle is not traveling on a bank road based on the GPS-converted lateral acceleration YG (GPS).

Returning to FIG. 2, a bank correction value calculation portion 12e is configured to calculate a bank correction value for correcting the lateral acceleration sensor value YG based on the determination made by the motion state estimation portion 12d as to whether or not the vehicle is traveling on a bank road. When the vehicle is traveling on a bank road, the influence of the gravity can be removed by correcting the lateral acceleration sensor value YG in accordance with the deviation from the GPS-converted lateral acceleration YG (GPS).

A lateral slip angle estimation portion 12f is configured to estimate a lateral slip angle β based on the yaw rate sensor value YR, the lateral acceleration sensor value YG, the vehicle speed V, and the bank correction value. The lateral slip angle β is given by the following equation: β=V/Vy, where Vy is a lateral speed of the vehicle. In this case, Vy cannot directly be observed, and hence an observer is used so as to estimate Vy. For example, the deviation between the yaw rate sensor value YR and the GPS-converted yaw rate YG (GPS) is fed back to a deviation of the actual lateral speed Vy, which cannot actually be observed, and an estimated lateral speed Vy*, to thereby calculate the lateral speed Vy. In order to deal with a non-linear area in which a cornering force is not proportional to β, a lateral acceleration YG1 corrected through use of the bank correction value and the yaw rate sensor value YR are used to successively calculate the cornering force, and a cornering power obtained by dividing by the previous lateral slip angle β is assigned to the observer, to thereby estimate a highly accurate lateral speed Vy so that the lateral angle β is calculated. Another technology may be used for the processing of calculating the lateral slip angle β, and there is no particular limitation on the calculation processing.

A brake control portion 12g is configured to execute the ABS based on the wheel speeds Vw and execute the VDC based on the lateral slip angle β, to thereby control the wheel cylinder pressure through the brake control apparatus 14. Stability during the vehicle braking is increased by executing the ABS. Moreover, the motion state of the vehicle can be controlled so that the lateral slip angle β is an appropriate value by executing the VDC, resulting in an increase in stability during the turning of the vehicle. Widely-known control processing can appropriately be applied to the ABS and the VDC, and there is no particular limitation on the ABS and the VDC. In addition, when the vehicle behavior is stably operated by the automatic driving control, a desired wheel cylinder pressure is calculated, and the wheel cylinder pressure is controlled through use of the brake control apparatus 14. The control based on the signal of the GPS sensor 1 out of this control is executed only when the signal of the GPS sensor 1 is acquired. When the signal of the GPS sensor 1 cannot be acquired, the output of the signal to the brake control apparatus 14 is stopped, to thereby secure safety.

A steering control portion 12h is configured to calculate, based on the lateral slip angle β, a steering assist torque for urging steering so that the behavior of the vehicle is stabilized, or a steered wheel angle for stabilizing the behavior of the vehicle, and control the steered wheel angles of the front wheels through use of the steering apparatus 15, to thereby increase the travel stability of the vehicle. This control is executed only when the signal for the GPS sensor 1 can be acquired. When the signal of the GPS sensor 1 cannot be acquired, the output of a signal to the steering apparatus 15 is stopped, to thereby secure safety. The control for the steering apparatus 15 may be executed by other automatic driving control, and there is no particular limitation on the control for the steering apparatus 15.

According to the first embodiment, the following effects are provided.

(1) The controller 12 includes: the input portion (first vehicle behavior signal input portion) configured to input the GPS-converted lateral acceleration YG (GPS) (first vehicle behavior signal) obtained based on the position information on the own vehicle acquired by the GPS sensor 1 and the speed in the longitudinal direction of the own vehicle; and the input portion (second vehicle behavior signal input portion) configured to input the lateral acceleration sensor value YG (second vehicle behavior signal) detected by the lateral acceleration sensor 3 (vehicle behavior detection portion). The controller 12 estimates whether or not the vehicle is traveling on a bank road (the first motion state of the own vehicle) based on the GPS-converted lateral acceleration YG (GPS) and the lateral acceleration sensor value YG.

The GPS sensor 1 is not influenced by the gravity, and hence the accuracy of estimation of the motion state of the vehicle can be increased.

(2) The motion state of the own vehicle is determined based on the GPS-converted lateral acceleration YG (GPS) and the lateral acceleration sensor value YG, and hence the accuracy of estimating whether or not the vehicle is traveling on a bank road can be increased.

(3) The controller 12 includes the input portion (third vehicle behavior signal input portion) configured to input the yaw rate-converted lateral acceleration YG (YR) (third vehicle behavior signal, which is the third lateral acceleration) obtained based on the yaw rate sensor value YR detected by the yaw rate sensor 2 and the vehicle speed V, which is the speed in the longitudinal direction of the own vehicle. The controller 12 estimates whether or not the vehicle is spinning (the second motion state of the own vehicle) based on the lateral acceleration sensor value YG and the yaw rate-converted lateral acceleration YG (YR).

Thus, the accuracy of estimation of the spin state can be increased.

(4) The GPS-converted lateral acceleration YG (GPS) obtained based on the position information on the own vehicle acquired from the GPS sensor 1 and the speed V in the longitudinal direction of the own vehicle, the lateral acceleration sensor value YG detected by the lateral acceleration sensor 3, and the yaw rate-converted lateral acceleration YG (YR) obtained based on the yaw rate sensor value YR detected by the yaw rate sensor 2 and the speed V in the longitudinal direction of the own vehicle are used. When the signal of the GPS sensor 1 is acquired, the command to move the own vehicle toward a direction in which the behavior of the own vehicle is more stabilized than when the signal of the GPS sensor 1 cannot be acquired is output to the brake control apparatus 14 and/or the steering apparatus 15 (the actuator portions relating to the steering and the braking/driving of the own vehicle).

Thus, the accuracy of estimation of the motion state of the vehicle can be increased, and the behavior of the vehicle can be stabilized. A vehicle employing this embodiment is caused to travel on a road surface of a low-μ road having a state in which the slow spin occurs. Then, the vehicle behavior during the slow spin in a state in which the position information can be received by the GPS sensor 1 mounted on the vehicle and the vehicle behavior in a state in which the position information cannot be received (for example, an antenna is shielded) are compared with each other. In this case, the vehicle behavior is stabilized more in the state in which the position information can be received than in the state in which the position information cannot be received.

### Second Embodiment

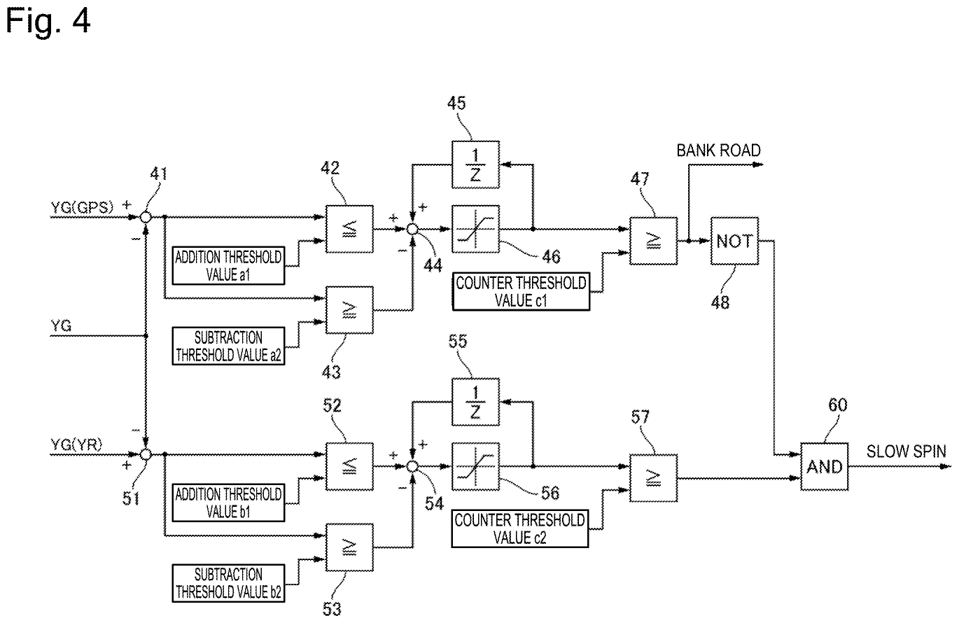

A description is now given of a second embodiment of the present invention, to which the idea of the control processing in the first embodiment is applied. FIG. 4 is a control block diagram for illustrating a control configuration of the motion state estimation portion 12d in the second embodiment.

A first deviation calculation portion 41 is configured to calculate a first deviation between the GPS-converted lateral acceleration YG (GPS) and the lateral acceleration sensor value YG.

A first addition processing portion 42 is configured to determine whether or not the first deviation is equal to or larger than an addition threshold value a1. The first addition processing portion 42 outputs “1” when the first deviation is equal to or larger than the addition threshold value a1, and outputs “0” otherwise.

A first subtraction processing portion 43 is configured to determine whether or not the first deviation is equal to or smaller than a subtraction threshold value a2. The first subtraction processing portion 43 outputs “1” when the first deviation is equal to or smaller than the subtraction threshold value a2, and outputs “0” otherwise.

A first counter 44 is configured to add the value output from the first addition processing portion 42, and subtract the value output from the first subtraction processing portion 43. Moreover, the first counter 44 is configured to add a previous first count value, which has passed a limiter 46, from a previous-value output portion 45, to thereby calculate the first count value for this time.

A bank determination portion 47 is configured to determine whether or not the first count value is equal to or larger than a first counter threshold value c1. When the first count value is equal to or larger than the first counter threshold value c1, the bank determination portion 47 determines that the vehicle is traveling on a bank road, and outputs “1”. When the first count value is smaller than the first counter threshold value c1, the bank determination portion 47 outputs “0”. When the bank determination portion 47 determines that the vehicle is traveling on a bank road, and thus outputs “1”, the bank correction value calculation portion 12e calculates the bank correction value. Through use of the counter in the evaluation of the magnitude of the deviation, filtering processing can be applied, and hence resistance against noise can be increased. This is because the position information of the GPS sensor 1 particularly contains a large amount of noise.

A signal conversion portion 48 is configured to determine whether or not the value output from the bank determination portion 47 is “1”. The signal conversion portion 48 outputs “0” when the output value is “1”, and outputs “1” when the output value is “0”. In other words, when it is determined that the vehicle is traveling on a bank road, “0” is output, and when it is determined that the vehicle is traveling on a flat road, “1” is output.

A second deviation calculation portion 51 is configured to calculate a second deviation between the yaw rate-converted lateral acceleration YG (YR) and the lateral acceleration sensor value YG.

A second addition processing portion 52 is configured to determine whether or not the second deviation is equal to or larger than an addition threshold value b1. The second addition processing portion 52 outputs “1” when the second deviation is equal to or larger than the addition threshold value b1, and outputs “0” otherwise.

A second subtraction processing portion 53 is configured to determine whether or not the second deviation is equal to or smaller than a subtraction threshold value b2. The second subtraction processing portion 53 outputs “1” when the second deviation is equal to or smaller than the subtraction threshold value b2, and outputs “0” otherwise.

A second counter 54 is configured to add the value output from the second addition processing portion 52, and subtract the value output from the second subtraction processing portion 53. Moreover, the second counter 54 is configured to add a previous second count value, which has passed a limiter 56, from a previous-value output portion 55, to thereby calculate the second count value for this time.

A spin determination portion 57 is configured to determine whether or not the second count value is equal to or larger than a second counter threshold value c2. When the second count value is equal to or larger than the second counter threshold value c2, the spin determination portion 57 outputs “1”. When the second count value is smaller than the second counter threshold value c2, the spin determination portion 57 outputs “0”. In other words, when it is determined that the vehicle is spinning, “1” is output, and when it is determined that the vehicle is not spinning, “0” is output.

The addition threshold value a1 is set to a value larger than the addition threshold value b1. The subtraction threshold value a2 is set to a value larger than the subtraction threshold value b2. The second counter threshold value c2 is set to a value larger than the first counter threshold value c1. That is, this configuration is provided so that the flat-road determination intervenes earlier than the spin determination. If there is provided such a configuration that the spin determination is made earlier, the spin determination is earlier at the time of an entrance into a bank, and the bank correction value may be limited as a result of an incorrect determination that a slow spin is occurring. Moreover, when a slow spin occurs immediately after the road changes from a bank road to a flat road, it is required to determine that the road is a flat road at an early stage. However, when the flat-road determination is finished earlier than the spin determination, an incorrect determination may be made. Thus, the accuracy of determination for the slow spin is increased by providing such a setting that a1>b1, a2≥b2, and c1>c2 so that the threshold value for the spin determination is larger than the threshold value for the flat-road determination.

A slow spin determination portion 60 is configured to determine whether or not a slow spin is occurring based on a combination of the value output by the signal conversion portion 48 and the value output by the spin determination portion 57. Only when the output value of the signal conversion portion 48 is “1” (that is, the determination that the vehicle is traveling on a flat road) and the output value of the spin determination portion 57 is “1” (that is, the determination is that the spin is occurring), the slow spin determination portion 60 determines that the vehicle is in the slow spin state. When the output value of the bank determination portion 48 is “0”, the slow spin determination portion 60 determines that the vehicle is traveling on a bank road, and does not make the slow spin determination. In this manner, when the bank determination or the spin determination based on the deviation is to be made, an incorrect determination due to the sensor error and the noise is avoided by introducing the counters. Moreover, the incorrect determination can further be reduced by introducing the counter to both of the bank determination and the spin determination.

(5) The controller 12 estimates the spin state only when the first count value (the value indicating the first deviation between the GPS-converted lateral acceleration YG (GPS) and the yaw rate sensor value YR is small) exceeds the first counter threshold value c1.

That is, only when it is determined that the vehicle is traveling on a flat road, the second deviation between the yaw rate-converted lateral acceleration YG (YR) and the lateral acceleration sensor value YG is evaluated as a spin component, and it is determined that the vehicle tends to spin when a state in which the second deviation is equal to or larger than the addition threshold value a2 continues. While the determination for a flat road is made preferentially to secure redundancy by providing the two determination portions, the second deviation is treated as the spin component only when the vehicle is traveling on a flat road. In this manner, it is possible to make an early determination for the spin.

(6) The controller 12 estimates the spin state based on whether or not the second count value (the value indicating that the second deviation between the yaw rate-converted lateral acceleration YG (YR) and the lateral acceleration sensor value YG is large) exceeds the second counter threshold value c2 larger than the first counter threshold value c1. The following concerns can be suppressed by providing the setting that the threshold value for the spin determination is larger than the threshold value for the flat-road determination. Specifically, when the spin determination is configured to be made earlier than the flat-road determination for the determination of the respective threshold values, the spin determination is completed earlier at the time of the entrance into a bank, and an incorrect determination that a slow spin is occurring may be made, resulting in a restriction on the bank correction. Therefore, the threshold values are required to be set so that the flat-road determination is made earlier and more quickly than the spin determination. Meanwhile, the flat-road determination is required to be immediately finished in consideration of the possibility that a slow spin occurs immediately after the end of a bank, but when the flat-road determination is finished earlier than the spin determination, an incorrect determination may be made. Those concerns can be suppressed.

(7) The controller 12 estimates a bank road earlier than the estimation of whether or not the vehicle is spinning.

Therefore, the concerns described in the section “(6)” can be suppressed by causing the flat-road determination to intervene earlier than the spin determination.

(8) The motion state estimation portion 12d inputs the GPS-converted lateral acceleration YG (GPS) from which the noise is removed.

The GPS-converted lateral acceleration YG (GPS) contains a large amount of noise, and it is thus difficult to directly use the GPS-converted lateral acceleration YG (GPS). Therefore, an incorrect determination can be suppressed by using the filter to remove the noise.

### Third Embodiment

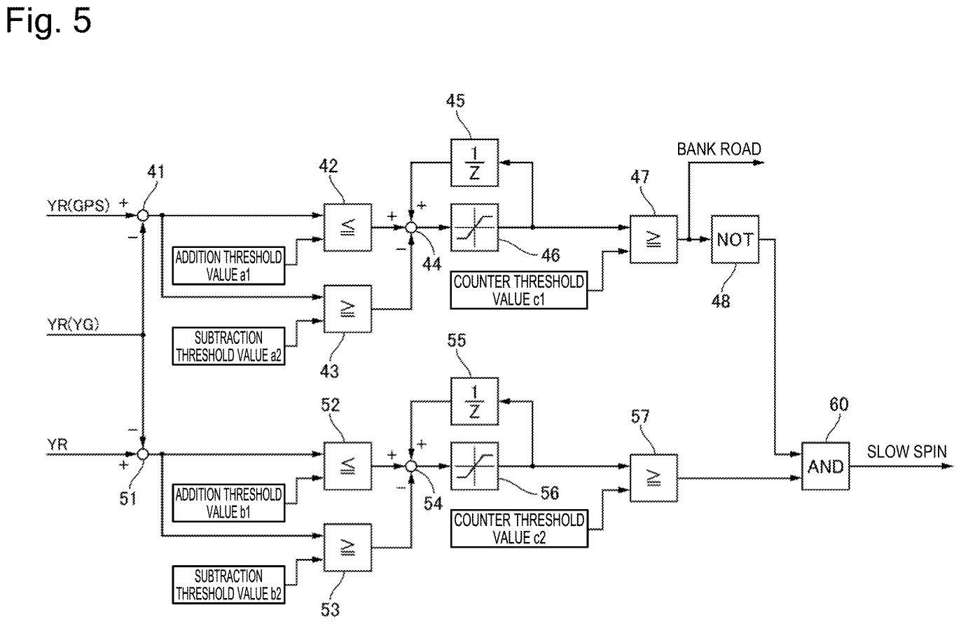

A description is now given of a third embodiment of the present invention. A basic configuration is the same as that of the second embodiment, and hence a description is given only of differences from the second embodiment. FIG. 5 is a control block diagram for illustrating a control configuration of the motion state estimation portion 12d in the third embodiment. In the second embodiment, the lateral acceleration sensor value YG, the GPS-converted lateral acceleration YG (GPS), and the yaw rate-converted lateral acceleration YG (YR) are used for the bank determination and the spin determination. In contrast, the third embodiment is different from the second embodiment in that the yaw rate sensor value YR, the GPS-converted yaw rate YR(GPS), and a lateral acceleration-converted yaw rate YR(YG) are used for the bank determination and the spin determination. In this case, the lateral acceleration-converted yaw rate YR(YG) is given by the following equation: YR(YG)=YG/V. Aa s result, the same actions and effects as those in the second embodiment are provided.

### Fourth Embodiment

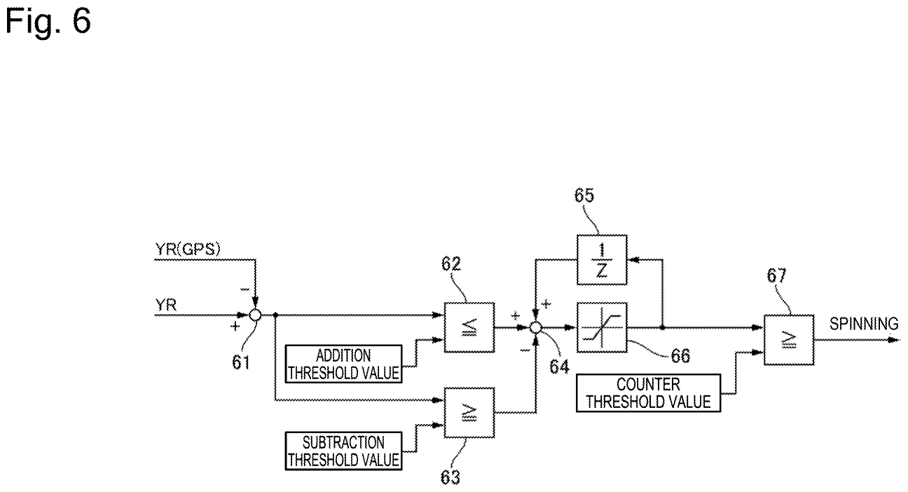

A description is now given of a fourth embodiment. A basic configuration is the same as that of the third embodiment, and hence a description is given only of differences from the third embodiment. In the first to third embodiments, whether or not the vehicle is traveling on a bank road and whether or not the vehicle is spinning are individually determined in order to detect a slow spin. Only when it is determined that the vehicle is traveling not on a bank road but on a flat road, it is determined whether or not the vehicle is spinning, to thereby detect a slow spin. In contrast, the fourth embodiment is different from the first to third embodiments in that the GPS-converted yaw rate YR(GPS) and the yaw rate sensor value YR are used to determine whether or not the vehicle is spinning. In other words, it is determined whether or not the vehicle is spinning without determining whether or not the vehicle is traveling on a bank road. FIG. 6 is a control block diagram for illustrating spin determination processing in the fourth embodiment.

A deviation calculation portion 61 is configured to calculate a deviation between the yaw rate sensor value YR and the GPS-converted yaw rate YR(GPS).

An addition processing portion 62 is configured to determine whether or not the deviation is equal to or larger than an addition threshold value. The addition processing portion 62 outputs “1” when the deviation is equal to or larger than the addition threshold value, and outputs “0” otherwise.

A subtraction processing portion 63 is configured to determine whether or not the deviation is equal to or smaller than a subtraction threshold value. The subtraction processing portion 63 outputs “1” when the deviation is equal to or smaller than the subtraction threshold value, and outputs “0” otherwise.

A counter 64 is configured to add the value output from the addition processing portion 62, and subtract the value output from the subtraction processing portion 63. Moreover, the counter 64 is configured to add a previous count value, which has passed a limiter 66, from a previous-value output portion 65, to thereby calculate the count value for this time.

A spin determination portion 67 is configured to determine whether or not the count value is equal to or larger than a counter threshold value. The spin determination portion 67 outputs “1” when the count value is equal to or larger than the counter threshold value, and outputs “0” when the count value is smaller than the counter threshold value. In other words, when it is determined that the vehicle is spinning, “1” is output, and when it is determined that the vehicle is not spinning, “0” is output.

That is, the GPS-converted yaw rate YR(GPS) is the yaw rate calculated based on the value of the GPS sensor 1, and is not influenced by the gravity. Thus, the spin state can be detected by appropriately setting the respective types of threshold value even when the vehicle is traveling on a bank road. In the first embodiment, the spin determination during the travel on the bank road is avoided in order to detect a slow spin, but the fourth embodiment may be combined with the first embodiment so that the spin determination may be made as in the fourth embodiment when it is determined that the vehicle is traveling on a bank road.

(9) The controller 12 estimates the motion state of the own vehicle based on the GPS-converted yaw rate YR(GPS) and the yaw rate sensor value YR.

Thus, the accuracy of estimation of the spin state can be increased even during the travel on a bank.

### Other Embodiments

In the first embodiment, the position information on the own vehicle is acquired through use of the GPS sensor 1, but an external environment recognition sensor and map information may be combined so as to acquire the position information on the own vehicle. Moreover, the example in which the brake apparatus and the steering apparatus are used as the actuators so as to stabilize the travel state of the vehicle is described in the embodiments, but a drive source such as an engine or a motor may be controlled, or the embodiments may be applied to a suspension apparatus configured to control a vertical motion such as the pitch, the roll, and the bounce of the vehicle. Moreover, in the second embodiment, the counter is used so as to evaluate the deviation, but instead of using the counter, values processed by a filter, for example, a low-pass filter, may be compared with each other as the deviation so as to make the determination. Moreover, the example in which the brake unit 11 and the brake control apparatus 14 are based on the hydraulic pressure is described, but an electric friction braking apparatus, for example, an electric caliper, may be employed.

(Technical Ideas Understandable from Embodiments)

A description is now given of the technical idea (or technical solution; the same applies hereinafter) understandable from the embodiments described above. (1) According to one aspect of this technical idea, there is provided a vehicle motion state estimation apparatus including a controller, the controller including: a first vehicle behavior signal input portion configured to input a first vehicle behavior signal obtained based on acquired position information on an own vehicle and a speed in a longitudinal direction of the own vehicle; a second vehicle behavior signal input portion configured to input a second vehicle behavior signal detected by a vehicle behavior detection portion; and a motion state estimation portion configured to estimate a first motion state of the own vehicle based on the first vehicle behavior signal and the second vehicle behavior signal.

(2) According to a more preferred aspect of this technical idea, in the above-mentioned aspect, the first vehicle behavior signal is a first lateral acceleration, and the second vehicle behavior signal is a second lateral acceleration, and the motion state estimation portion is configured to estimate the first motion state of the own vehicle based on the first lateral acceleration and the second lateral acceleration.
(3) According to another preferred aspect of this technical idea, in any one of the above-mentioned aspects, the controller includes a third vehicle behavior signal input portion configured to input a third vehicle behavior signal, which is a third lateral acceleration obtained based on a yaw rate detected by the vehicle behavior detection portion and the speed in the longitudinal direction of the own vehicle, and the motion state estimation portion is configured to estimate a second motion state of the own vehicle based on the second lateral acceleration and the third lateral acceleration.
(4) According to yet another preferred aspect of this technical idea, in any one of the above-mentioned aspects, the motion state estimation portion is configured to estimate the second motion state only when a first count value calculated based on a deviation between the first lateral acceleration and the second lateral acceleration exceeds a first threshold value.
(5) According to still another preferred aspect of this technical idea, in any one of the above-mentioned aspects, the motion state estimation portion is configured to estimate the second motion state based on whether a second count value, which is calculated based on a deviation between the third lateral acceleration and the second lateral acceleration, exceeds a second threshold value larger than the first threshold value.
(6) According to still another preferred aspect of this technical idea, in any one of the above-mentioned aspects, the motion state estimation portion is configured to estimate the first motion state earlier than the second vehicle motion state.
(7) According to still another preferred aspect of this technical idea, in any one of the above-mentioned aspects, the first vehicle behavior signal input portion is configured to input the first lateral acceleration from which noise is removed.
(8) According to still another preferred aspect of this technical idea, in any one of the above-mentioned aspects, the first vehicle behavior signal is a first yaw rate, and the second vehicle behavior signal is a second yaw rate, and the motion state estimation portion is configured to estimate the first motion state of the own vehicle based on the first yaw rate and the second yaw rate.
(9) From another viewpoint, in one aspect of this technical idea, there is provided a vehicle motion state estimation method including: a first vehicle behavior signal input step of inputting a first vehicle behavior signal obtained based on acquired position information on an own vehicle, and a speed in a longitudinal direction of the own vehicle; a second vehicle behavior signal input step of inputting a second vehicle behavior signal detected by a vehicle behavior detection portion; and a first vehicle motion state estimation step of estimating a first motion state of the own vehicle based on the first vehicle behavior signal and the second vehicle behavior signal.
(10) According to a more preferred aspect of this technical idea, in the above-mentioned aspect, the first vehicle behavior signal is a first lateral acceleration, and the second vehicle behavior signal is a second lateral acceleration, and the first vehicle motion state estimation step includes estimating the first motion state of the own vehicle based on the first lateral acceleration and the second lateral acceleration.
(11) According to yet another preferred aspect of this technical idea, in any one of the above-mentioned aspects, the vehicle motion state estimation method further includes: a third vehicle behavior signal input step of inputting a third vehicle behavior signal, which is a third lateral acceleration obtained based on a yaw rate detected by the vehicle behavior detection portion and the speed in the longitudinal direction of the own vehicle; and a second vehicle motion state estimation step of estimating a second motion state of the own vehicle based on the second lateral acceleration and the third lateral acceleration.
(12) According to still another preferred aspect of this technical idea, in any one of the above-mentioned aspects, the first vehicle behavior signal is a first yaw rate, and the second vehicle behavior signal is a second yaw rate, and the first vehicle motion state estimation step includes estimating the first motion state of the own vehicle based on the first yaw rate and the second yaw rate.
(13) From yet another viewpoint, in one aspect of this technical idea, there is provided a vehicle motion state estimation system including: an own vehicle position acquisition portion configured to acquire position information on an own vehicle; a longitudinal speed detection portion configured to detect a longitudinal-direction speed of the own vehicle; a vehicle behavior signal calculation portion configured to obtain a first vehicle behavior signal based on the position information on the own vehicle and the longitudinal-direction speed of the own vehicle; a vehicle behavior detection portion configured to detect a second vehicle behavior signal, which is a vehicle behavior of the own vehicle; and a first vehicle motion state estimation portion configured to estimate a first motion state of the own vehicle based on the first vehicle behavior signal and the second vehicle behavior signal.
(14) According to a more preferred aspect of this technical idea, in the above-mentioned aspect, the first vehicle behavior signal is a first lateral acceleration, and the second vehicle behavior signal is a second lateral acceleration, and the first vehicle motion state estimation portion is configured to estimate the first motion state of the own vehicle based on the first lateral acceleration and the second lateral acceleration.
(15) According to yet another preferred aspect of this technical idea, in any one of the above-mentioned aspects, the vehicle motion state estimation system further includes: a yaw rate detection portion configured to detect a yaw rate of the own vehicle; a third vehicle behavior signal calculation portion configured to obtain a third vehicle behavior signal, which is a third lateral acceleration, based on the yaw rate and the longitudinal-direction speed of the own vehicle; and a second vehicle motion state estimation portion configured to estimate a second motion state of the own vehicle based on the second lateral acceleration and the third lateral acceleration.
(16) According to still another preferred aspect of this technical idea, in any one of the above-mentioned aspects, the first vehicle behavior signal is a first yaw rate, and the second vehicle behavior signal is a second yaw rate, and the first vehicle motion state estimation portion is configured to estimate the first motion state of the own vehicle based on the first yaw rate and the second yaw rate.
(17) From still another viewpoint, in one aspect of this technical idea, there is provided a vehicle motion control apparatus configured to: use a GPS-converted lateral acceleration obtained based on position information on an own vehicle acquired from a GPS sensor and a speed in a longitudinal direction of the own vehicle, a lateral acceleration detected by a lateral acceleration sensor, and a yaw rate-converted lateral acceleration obtained based on a yaw rate detected by a yaw rate sensor and the speed in the longitudinal direction of the own vehicle; and output, when a signal of the GPS sensor is acquired, a command to move the own vehicle toward a direction in which a behavior of the own vehicle is more stabilized than when the signal of the GPS sensor fails to be acquired, to an actuator portion relating to at least one of steering and braking/driving of the own vehicle.

The present invention is not limited to the embodiment described above and covers various modification examples. For example, the embodiment described above is a detailed description written for an easy understanding of the present invention, and the present invention is not necessarily limited to a configuration that includes all of the described components. The configuration of one embodiment may partially be replaced by the configuration of another embodiment. The configuration of one embodiment may be joined by the configuration of another embodiment. In each embodiment, a portion of the configuration of the embodiment may have another configuration added thereto or removed therefrom, or may be replaced by another configuration.

The present application claims a priority based on Japanese Patent Application No. 2017-174566 filed on Sep. 12, 2017. All disclosed contents including Specification, Scope of Claims, Drawings, and Abstract of Japanese Patent Application No. 2017-174566 filed on Sep. 12, 2017 are incorporated herein by reference in their entirety.

### REFERENCE SIGNS LIST

1 GPS sensor, 2 yaw rate sensor, 3 lateral acceleration sensor, 4 wheel speed sensor, 11FL, 11FR, 11RL, 11RR brake unit, 12 controller, 14 brake control apparatus, 15 steering apparatus, 1FL, 1FR front wheel, 1RL, 1RR rear wheel

1. A vehicle motion state estimation apparatus, comprising a controller,
wherein the controller includes:
a first vehicle behavior signal input portion configured to input a first vehicle behavior signal obtained based on acquired position information on an own vehicle and a speed in a longitudinal direction of the own vehicle;
a second vehicle behavior signal input portion configured to input a second vehicle behavior signal detected by a vehicle behavior detection portion; and
a motion state estimation portion configured to estimate a first motion state of the own vehicle based on the first vehicle behavior signal and the second vehicle behavior signal.

2. The vehicle motion state estimation apparatus according to claim 1,
wherein the first vehicle behavior signal is a first lateral acceleration, and the second vehicle behavior signal is a second lateral acceleration, and
wherein the motion state estimation portion is configured to estimate the first motion state of the own vehicle based on the first lateral acceleration and the second lateral acceleration.

3. The vehicle motion state estimation apparatus according to claim 2,
wherein the controller includes a third vehicle behavior signal input portion configured to input a third vehicle behavior signal, which is a third lateral acceleration obtained based on a yaw rate detected by the vehicle behavior detection portion and the speed in the longitudinal direction of the own vehicle, and
wherein the motion state estimation portion is configured to estimate a second motion state of the own vehicle based on the second lateral acceleration and the third lateral acceleration.

4. The vehicle motion state estimation apparatus according to claim 3, wherein the motion state estimation portion is configured to estimate the second motion state only when a first count value calculated based on a deviation between the first lateral acceleration and the second lateral acceleration exceeds a first threshold value.

5. The vehicle motion state estimation apparatus according to claim 4, wherein the motion state estimation portion is configured to estimate the second motion state based on whether a second count value, which is calculated based on a deviation between the third lateral acceleration and the second lateral acceleration, exceeds a second threshold value larger than the first threshold value.

6. The vehicle motion state estimation apparatus according to claim 3, wherein the motion state estimation portion is configured to estimate the first motion state earlier than the second vehicle motion state.

7. The vehicle motion state estimation apparatus according to claim 2, wherein the first vehicle behavior signal input portion is configured to input the first lateral acceleration from which noise is removed.

8. The vehicle motion state estimation apparatus according to claim 1,
wherein the first vehicle behavior signal is a first yaw rate, and the second vehicle behavior signal is a second yaw rate, and
wherein the motion state estimation portion is configured to estimate the first motion state of the own vehicle based on the first yaw rate and the second yaw rate.

9. A vehicle motion state estimation method, comprising:
a first vehicle behavior signal input step of inputting a first vehicle behavior signal obtained based on acquired position information on an own vehicle, and a speed in a longitudinal direction of the own vehicle;
a second vehicle behavior signal input step of inputting a second vehicle behavior signal detected by a vehicle behavior detection portion; and
a first vehicle motion state estimation step of estimating a first motion state of the own vehicle based on the first vehicle behavior signal and the second vehicle behavior signal.

10. The vehicle motion state estimation method according to claim 9,
wherein the first vehicle behavior signal is a first lateral acceleration, and the second vehicle behavior signal is a second lateral acceleration, and
wherein the first vehicle motion state estimation step includes estimating the first motion state of the own vehicle based on the first lateral acceleration and the second lateral acceleration.

11. The vehicle motion state estimation method according to claim 10, further comprising:
a third vehicle behavior signal input step of inputting a third vehicle behavior signal, which is a third lateral acceleration obtained based on a yaw rate detected by the vehicle behavior detection portion and the speed in the longitudinal direction of the own vehicle; and
a second vehicle motion state estimation step of estimating a second motion state of the own vehicle based on the second lateral acceleration and the third lateral acceleration.

12. The vehicle motion state estimation method according to claim 9,
wherein the first vehicle behavior signal is a first yaw rate, and the second vehicle behavior signal is a second yaw rate, and
wherein the first vehicle motion state estimation step includes estimating the first motion state of the own vehicle based on the first yaw rate and the second yaw rate.

13. A vehicle motion state estimation system, comprising:
an own vehicle position acquisition portion configured to acquire position information on an own vehicle;
a longitudinal speed detection portion configured to detect a longitudinal-direction speed of the own vehicle;
a vehicle behavior signal calculation portion configured to obtain a first vehicle behavior signal based on the position information on the own vehicle and the longitudinal-direction speed of the own vehicle;
a vehicle behavior detection portion configured to detect a second vehicle behavior signal, which is a vehicle behavior of the own vehicle; and
a first vehicle motion state estimation portion configured to estimate a first motion state of the own vehicle based on the first vehicle behavior signal and the second vehicle behavior signal.

14. The vehicle motion state estimation system according to claim 13,
wherein the first vehicle behavior signal is a first lateral acceleration, and the second vehicle behavior signal is a second lateral acceleration, and
wherein the first vehicle motion state estimation portion is configured to estimate the first motion state of the own vehicle based on the first lateral acceleration and the second lateral acceleration.

15. The vehicle motion state estimation system according to claim 14, further comprising:
a yaw rate detection portion configured to detect a yaw rate of the own vehicle;
a third vehicle behavior signal calculation portion configured to obtain a third vehicle behavior signal, which is a third lateral acceleration, based on the yaw rate and the longitudinal-direction speed of the own vehicle; and
a second vehicle motion state estimation portion configured to estimate a second motion state of the own vehicle based on the second lateral acceleration and the third lateral acceleration.

16. The vehicle motion state estimation system according to claim 13,
wherein the first vehicle behavior signal is a first yaw rate, and the second vehicle behavior signal is a second yaw rate, and
wherein the first vehicle motion state estimation portion is configured to estimate the first motion state of the own vehicle based on the first yaw rate and the second yaw rate.

17. A vehicle motion control apparatus, which is configured to:
use:
a GPS-converted lateral acceleration obtained based on position information on an own vehicle acquired from a GPS sensor and a speed in a longitudinal direction of the own vehicle;
a lateral acceleration detected by a lateral acceleration sensor; and
a yaw rate-converted lateral acceleration obtained based on a yaw rate detected by a yaw rate sensor and the speed in the longitudinal direction of the own vehicle; and
output, when a signal of the GPS sensor is acquired, a command to move the own vehicle toward a direction in which a behavior of the own vehicle is more stabilized than when the signal of the GPS sensor fails to be acquired, to an actuator portion relating to at least one of steering and braking/driving of the own vehicle.
